(19) United States
(12) Patent Application Publication
(10) Pub. No.: US 2014/0372859 A1
(43) Pub. Date: Dec. 18, 2014

(54) METHODS AND SYSTEMS FOR DIGITAL INFORMATION MODELING FOR CODES AND STANDARDS COMPLIANCE

(71) Applicant: CARNEGIE MELLON UNIVERSITY, a Pennsylvania Non-Profit Corporation, Pittsburgh, PA (US)

(72) Inventors: Khee Poh Lam, Pittsburgh, PA (US); Jie Zhao, Pittsburgh, PA (US); Rongpeng Zhang, Berkeley, CA (US); Omer T. Karaguzel, Downers Grove, IL (US)

(73) Assignee: CARNEGIE MELLON UNIVERSITY, a Pennsylvania Non-Profit Corporation, Pittsburgh, PA (US)

(21) Appl. No.: 14/304,239

(22) Filed: Jun. 13, 2014

Related U.S. Application Data
(60) Provisional application No. 61/956,638, filed on Jun. 13, 2013.

(51) Int. Cl. G06F 17/24; G06Q 30/00

(52) U.S. Cl. CPC G06F 17/243; G06Q 30/018
USPC 715/221

(57) ABSTRACT

This invention describes methods and systems to efficiently map and extract information from digital representations of buildings for use for a variety of purposes, including but not limited to the performance of dynamic simulations of building performance, and for codes and standards compliance.

### CROSS-REFERENCE TO RELATED APPLICATIONS

This application claims priority to U.S. Provisional Application Ser. No. 61/956,638, titled METHODS AND SYSTEMS FOR DIGITAL INFORMATION MODELING FOR CODES AND STANDARDS COMPLIANCE, filed Jun. 13, 2013, incorporated by reference herein in its entirety.

### STATEMENT REGARDING FEDERALLY-SPONSORED RESEARCH AND DEVELOPMENT

This invention was made with partial government support under NSF EFRI grant Prime Award No. EFRI-1038139, Sub-Award No. 181590112001. The government has certain rights in this invention.

### FIELD OF THE INVENTION

This invention relates to the field of designing, constructing and operating buildings. More particularly, this invention relates to methods to extract information from digital representations of buildings to enable efficient use of such information for various purposes, including but not limited to conducting performance simulations, and easing compliance with building codes and standards.

### BACKGROUND OF THE INVENTION

The processes of designing, constructing and operating buildings are complex undertakings that increasingly are performed using tools that create digital representations of various aspects of such buildings and their operations. These processes must be performed in compliance with an extensive range of building codes and standards that govern every aspect of the building, from detailed product specifications, to health and safety issues, as well as energy performance and indoor environmental quality. Present methods do not enable efficient integration of the information contained in the digital representations of building with the codes and standards that govern their construction and operation, leading to errors and inefficiencies. Present methods also do not enable the generation of performance simulations to assist with design decision making.

Green buildings aim to reduce the environmental impact by saving land, energy, water, and material, as well as creating a healthy, comfortable, and productive built environment for human beings. As a well-established and widely-adopted voluntary green building evaluation system, Leadership in Energy and Environmental Design (LEED) (USGBC (2011b), LEED 2009 for New Construction and Major Renovation, Washington, D.C., United States Green Building Council) has been recognized as a benchmark for green buildings internationally. In the United States alone, the LEED certification market has grown dramatically. The number of LEED certified projects has achieved a 103% average annual growth rate from 2000 to 2011 (Zhao, J. & Lam, K. P. (2012). “Influential factors analysis on LEED building markets in U.S. East Coast cities by using Support Vector Regression”, Sustainable Cities and Society, 5, 37-43). According to (Yudelson, J. (2008), Green Building Through Integrated Design (GreenSource Books)(e-book), McGraw Hill Professional), “Increased economic benefits are the prime driver of change for green buildings.” One of the major cost savings for green buildings is operation cost reduction by using less energy. Energy and Atmosphere (EA) section in the LEED 2009 New Construction and Major Innovation (LEED 2009 NC) uses energy cost saving, rather than actual energy consumption saving as the prerequisite (10% improvement than baseline) and the point calculation method. The EA section also has the highest possible points (35 out of 110) among all the 7 categories. This study focuses on meeting energy assessment criteria as per LEED as an exemplary rating system.

Life-cycle cost reduction is a driver for green buildings, but the “perceived higher costs” can be a barrier for adopting green buildings (Yudelson, 2008). The LEED submission process often requires significant amount of time and cost for the documentation. Regarding the cost premium incurred for green buildings, Kats (Kats, G., Braman, J. & James, M. J. (2010), Greening our built environment: costs, benefits, and strategies, ISLAND Press) states that “LEED certification does, but green design need not.” (Kats et al., 2010) Currently, Green Building Certification Institute (GBCI) handles LEED project submissions and certifications. An online system—LEED Online has been established for the LEED 2009 NC to receive project registration and submission (GBCI. (2014), “LEED Online”: Green Building Certification Institute. Available at: http://www.gbci.org/main-nav/building-certification/leed-online/about-leed-online.aspx). The LEED Online system is a useful tool, but the amount of effort to fill in the online PDF-format forms is considerable. Research shows the cost of LEED documentation is from $25,000 to $90,000, depending on the complexity of the project, team experience and level of certification (Yudelson, 2008), which can be the second biggest cost for the entire LEED certification process (Environmental-Building-News. (2012), “The Cost of LEED Project Certification”. Available at: http://www.buildinggreen.com/auth/article.cfm/2010/5/1/The-Cost-of-LEED-Certification/). Take the EA Prerequisite 2 for example. In order to fulfill the energy performance requirements, about 1300-1400 variables have to be filled in the PDF-format template for a medium size office building project (the number of variables may vary depending on the characteristics of the building project). Most of this data can be found in the result output file of a whole building energy simulation program.

The lack of team experience can also be an obstacle for LEED certification (Yudelson, 2008). Special training and guidance need to be provided. For example, a common way to demonstrate energy cost reduction is through whole building energy simulation. However, building energy modeling is a relatively new concept and beyond the traditional work scope of architects and engineers. Although research on building energy modeling has been conducted for decades since 1970s', the industry application of building energy modeling started from early 2000s' in accordance with the fast growing of EnergyStar and LEED certifications (Vaughn, K. (2011), “The “Push and Pull” of Energy Modeling Demand”. Available at: http://blog.rmi.org/ThePushPullEnergyModelingDemand, EPA. (2001), “The Power of Partnerships—ENERGY STAR® and Other Voluntary Programs”. Available at: http://www.energystar.gov/ia/partners/annualreports/annual_report_{—}2000.p df?a5f4-f2f9). To meet the need of the building energy modeling market, a new job category—Commercial Building Energy Modeler—was introduced by the US government in 2011 (DOE. (2011), “Job/Task Analysis for a Commercial Building Energy Modeler: Public Comment Draft”. Available at: http://www1.eere.energy.gov/buildings/commercial_initiative/pdfs/energy_modeler_jta_comment.pdf). Continuous guidance and training is still essential for the building industry with respect to LEED requirements.

Several software tools have been developed to facilitate the LEED submission process from different perspectives. “TRACE 700 can help document compliance with ASHRAE Standard 90.1 or validate the building's eligibility for LEED certification” by achieving the LEED EA Prerequisite 2 and Credit 1 (TRANE. (2013), “TRACE™ 700 and LEED®”. Available at: http://www.trane.com//COMMERCIAL/DNA/View.aspx?i=2396). Bentley's “AECOsim Compliance Manager” can “streamline the LEED certification process and maximize LEED credits” in the design stage (Bentley. (2013a), “AECOsim Compliance Manager”. Available at: http://www.bentley.com/en-US/Promo/AECOsim/aecosim+compliance+manager.htm). The corresponding energy simulation tool—“AECOsim Energy Simulator” uses EnergyPlus (DOE. (2012), “About EnergyPlus”. Available at: http://apps1.eere.energy.gov/buildings/energyplus/energyplus_about.cfm) engine and can generate LEED reports of “peak loads, annual energy calculations, energy consumptions, carbon emissions, and fuel costs” (Bentley. (2013b), “AECOsim Energy Simulator”. Available at: http://www.bentley.com/en-US/Promo/AECOsim/aecosim+energy+simulator.htm). Those tools can facilitate the LEED certification process in one way or another. However, these LEED functions are bundled with certain commercial energy model software program. Users have to create energy models using these commercial programs. Other public domain and widely used energy modeling tools, such as EnergyPlus and eQUEST, cannot be processed directly.

The “COMNET Energy Modeling Portal for LEED Online” was developed for eQUEST program to achieve the LEED EA Prerequisite 2 and Credit 1 (COMNET. (2012), “The COMNET Energy Modeling Portal for LEED Online”. Available at: http://www.comnet.org/mgp/sites/default/files/COMNET%20portal%20fact%20sheet_LEEDonline.pdf). The eQUEST energy model file (SIM-format) can be uploaded onto the web-based tool. Then the COMNET XML standard output file can be generated and uploaded to the LEED Online website fulfilling the submission templates. The COMNET tool is effective for eQUEST users to submit LEED energy performance data. However, this tool cannot provide all the information that the LEED EA Prerequisite 2 and Credit 1 requires. Other outside sources need to be manually included to complete the submission template.

Tools for calculating points in other LEED categories have also been developed. “IES VE-Toolkit for LEED” can calculate LEED points for Indoor Environment Quality (IEQ) Credit 8.1 daylighting performance, IEQ Credit 7.1 comfort criteria, Water Efficiency Prerequisite 1-3, and EA Credit 2 and 6 for renewable energy (IES. (2013), “VE-Toolkit for LEED”. Available at: http://www.iesve.com/software/toolkits/VE-Toolkit-for-LEED_{—}458). Huang et al. (Huang, Y. C., Lam, K. P. & Dobbs, G. (Year), “A Scalable Lighting Simulation Tool for Integrated Building Design”. Third National Conference of IBPSA-USA, 2008 Berkeley, Calif. IBPSA, 206-213) proposed a “Scalable Lighting Simulation Tool for Integrated Building Design”, which is able to calculate the LEED IEQ Credit 8.1 and 8.2 for daylight availability and external view availability, respectively (Huang et al., 2008). DesignBuilder daylighting calculation can also generate reports for LEED Credit 8.1 by using the Radiance calculation engine (DesignBuilder. (2011), “DesignBuilder Daylighting”. Available at: http://designbuilderusa.com/designbuilder-daylighting).

To facilitate the LEED submission in the EA category, improvements can be made in the following aspects. First, an online adaptable data structure should be introduced, to support various energy simulation tools and continuous updates on LEED requirements. Second, outside resources should be integrated in the tool to further reduce the manual input effort.

### SUMMARY OF THE INVENTION

This present invention describes methods and systems to efficiently map and extract information from digital representations of buildings for use for a variety of purposes, including but not limited to the performance of dynamic simulations of building performance, and for code and standards compliance.

This system will support (1) the creation of a detailed building information model during the design phase that can be subjected to various building performance simulation evaluations to assist design decision making and to be used for code and standard compliances; (2) modification of the design model during the construction and validated during the commissioning phases to become the as-built model; and (3) eventual continuous deployment during the operation phase as an integrated component of the building automation system (BAS) for conducting advanced predictive building control and optimization to reduce energy consumption and improve occupant comfort. The system enables a “living” building information model that will evolve throughout the entire building life-cycle.

The present invention (referred to herein as LEED Energy Performance Online Submission Tool (LEPOST)) is developed focusing on the two aspects above. A “LEEDXML-Reference” data structure is implemented to transform LEED standard into a dynamic data structure for interactively browsing and searching the standard. A “LEEDXML-Template” data structure is created to store and map building energy simulation output data into the actual LEED EA Prerequisite 2 and Credit 1 submission templates and calculate the achievable points. EnergyPlus, a whole building energy simulation tool that is officially supported and constantly updated by DOE, and eQUEST, a commonly used energy simulation tool in industry, are fully implemented in the current version of LEPOST. By using LEPOST, instead of filling in thousands variables manually, only about 20 variables (the number of variables is project-specific) need to be filled to generate the standard submission templates. The amount of time to prepare the EA Prerequisite 2 and Credit 1 documentation can be reduced from hours (if not days) to a matter of minutes.

LEED Energy Performance Online Submission Tool (LEPOST) uses XML-based information technology to transform the static LEED standard into repository dynamic data structure for interactively browsing and searching the standard, and automatically maps building energy simulation results to the LEED submission requirements.

The development of LEPOST directly contributes to the building industry by reducing the time required for the LEED documentation. The concept of LEPOST also contributes to data interoperability knowledge by demonstrating a viable solution to extract and map digital model information for various code and standard compliance purposes. Specifically,
LEPOST has the ability to complete LEED EA Prerequisite 2 and LEED EA Credit 1 submission templates with minimum manual inputs. Parts of the data that cannot be extracted from simulation result outputs are automatically collected from openly available online sources.
The XML-based “LEEDXML-Reference” and “LEEDXML-Template” data schema can be extended or updated fairly easily. This method provides a viable solution for the future adoption of LEED V4, or for other tools for extracting and mapping digital model information for code and standard compliance purposes.
The online platform can also support other building energy simulation tools besides EnergyPlus and eQUEST, such as TRNSYS (TRNSYS. (2012), “TRNSYS”. Available at: http://sel.me.wisc.edu/trnsys/features/features.html) or other energy simulation tools.
In practice, LEPOST can also help design teams perform design alternatives on various building envelope and systems to evaluate energy performance (LEED points) during the early design stage. Parametric design function is expected to be implemented in the second version of LEPOST. This function will allow users to create accounts and upload multiple design model files and compare the LEED rating results through the web interface.
From the technical point of view, using the XML and online platform, LEPOST can be seamlessly integrated with LEED Online or other LEED automation tools by using the similar LEEDXML data structure (USGBC. (2013), “LEED Automation”. Available at: http://www.usgbc.org/automation). One important part of the future work is integrating LEPOST with LEED Online.
A complete life-cycle building information mapping schema can be implemented. The Design-Build-Operate Energy Information Modeling (DBO-EIM) infrastructure has been proposed to “create a detailed and persistent energy model that can be used to reduce energy consumption and improve occupant comfort throughout the life-cycle of a building” (Zhao, J., Lam, K. P., Karaguzel, O. T. & Ahmadi, S. (2012), Design-Build-Operate Energy Information Modeling (DBO-EIM) for Green Buildings: Case Study of a Net Zero Energy Building. the 1st IBPSA Asia conference. Shanghai, China). LEPOST and other building performance evaluation processes can be further integrated in the DBO-EIM framework.

It is an object of the present invention to describe methods and systems to enable efficient and accurate integration between digital representations of buildings and the codes and standards that govern their design, construction and operations.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 is a schematic of the backend functional structure of the present invention (referred to herein as LEPOST);

FIG. 2 is a Reference content transformation diagram of the present invention;

FIG. 3 is an illustration of an exemplary The LEEDXML-Reference screenshot in the XMLSpy program of the present invention;

FIGS. 4A-D are Error feedback examples of the present invention;

FIGS. 5(a)-(d) are the examples of EnergyPlus output file, LEEDXML-Template and EnergyPlus mapping rule of the present invention;

FIG. 6 is an example of LEEDXML-Template EAp2 converted to HTML via XSLT Transformation of the present invention;

FIG. 7 is a schematic of the user interface navigation structure of the present invention;

FIG. 8 is an exemplary screenshot of LEPOST front page of the present invention;

FIG. 9 is an exemplary screenshot of LEPOST reference page of the present invention;

FIG. 10 is an exemplary screenshot of LEPOST submission page Step 1 for choosing EnergyPlus or eQUEST;

FIG. 11(a) is an exemplary screenshot of LEPOST submission page Step 2 for instructions to prepare EnergyPlus model output file;

FIG. 11(b) is an exemplary screenshot of LEPOST submission page Step 2 for instructions to prepare eQUEST model output file;

FIG. 12(a) is an exemplary screenshot of LEPOST submission page Step 3 for user manual input; FIG. 12(b) is an exemplary screenshot of LEPOST submission page Step 3 for user manual upload ZIP file;

FIG. 13 is an exemplary screenshot of LEPOST submission result page;

FIG. 14(a) is a sample page of LEED EAP-2 submission template;

FIG. 14(b) is an example of EnergyStar Target Finder result page; and

FIG. 15 is the core method of the present invention to extract digital model information for codes and standards compliance, and reporting.

### DETAILED DESCRIPTION OF THE INVENTION

The present invention 10 describes methods and systems for efficient extraction of information from digital representations of building and the use of such information for various purposes, including but not limited to the performance of building simulation evaluations, and the compliance with building codes and standards.

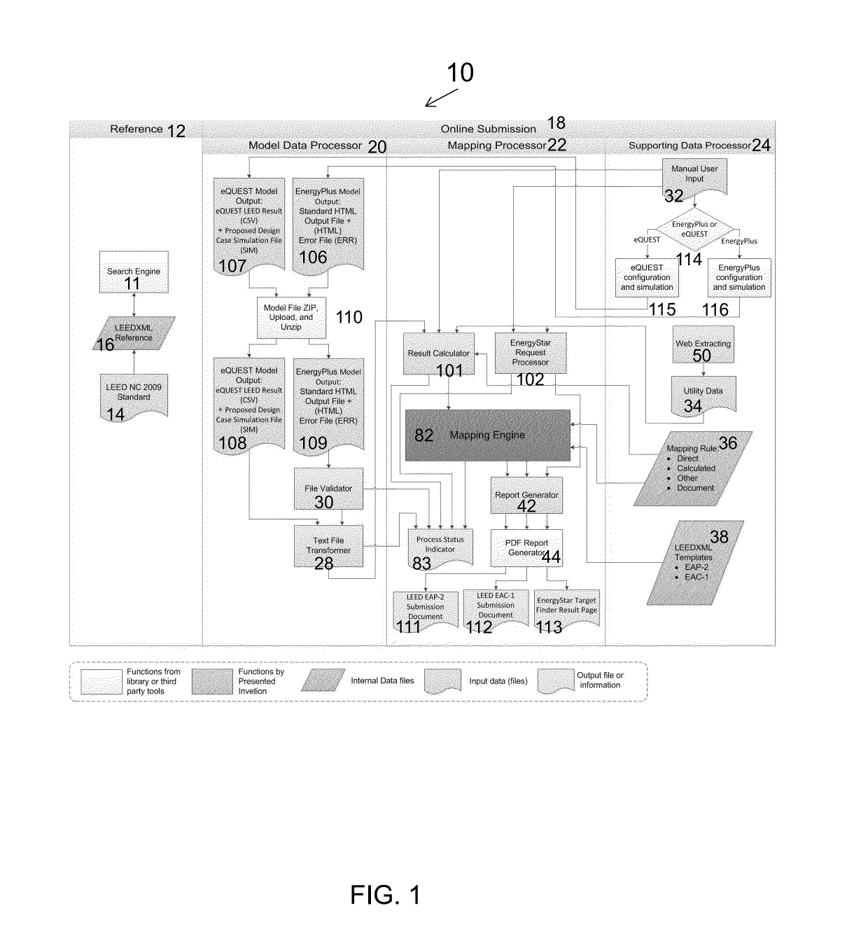

LEPOST uses a web-based information infrastructure. Techniques implemented in the backend include Servlet, JSP and XPath (TRANE. (2013), “TRACE™ 700 and LEED®”. Available at: http://www.trane.com//COMMERCIAL/DNA/View.aspx?i=2396; W3C. (1999), “XML Path Language”. Available at: http://www.w3.org/TR/xpath/; Apache. (2012), “Interface Servlet”. Available at: http://tomcat.apache.org/tomcat-5.5-doc/servletapi/javax/servlet/Servlet.html). In the frontend, HTML and jQuery (jQuery. (2013), “jQuery”. Available at: http://jquery.com/) are used for the implementation. LEPOST supports the following web browsers and their newer versions: IE8.0, Chrome 19.0, Firefox 12.0, and Safari 5.1 for PCs; and Safari 5.1 for Macs. FIG. 1 shows the backend functional structure of the system.

Now turning to FIG. 1 illustrating a schematic of the backend functional structure of the present invention. The “Reference” function 12 provides a searchable dynamic version of the LEED 2009 NC standard 14. LEEDXML-Reference file 16 is used for the web display and user interaction. The search is performed by Search Engine 11, which can be any commercially available search engine. The sub-functions in the “Online Submission” function 18 are “Model File Processor” 20, “Mapping Processor” 22, and “Supporting Data Processor” 24.

Reference Function 12

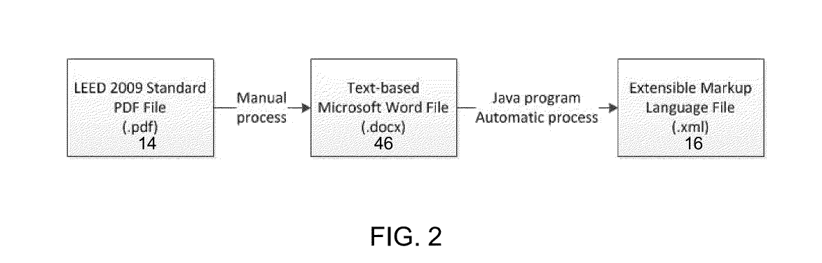

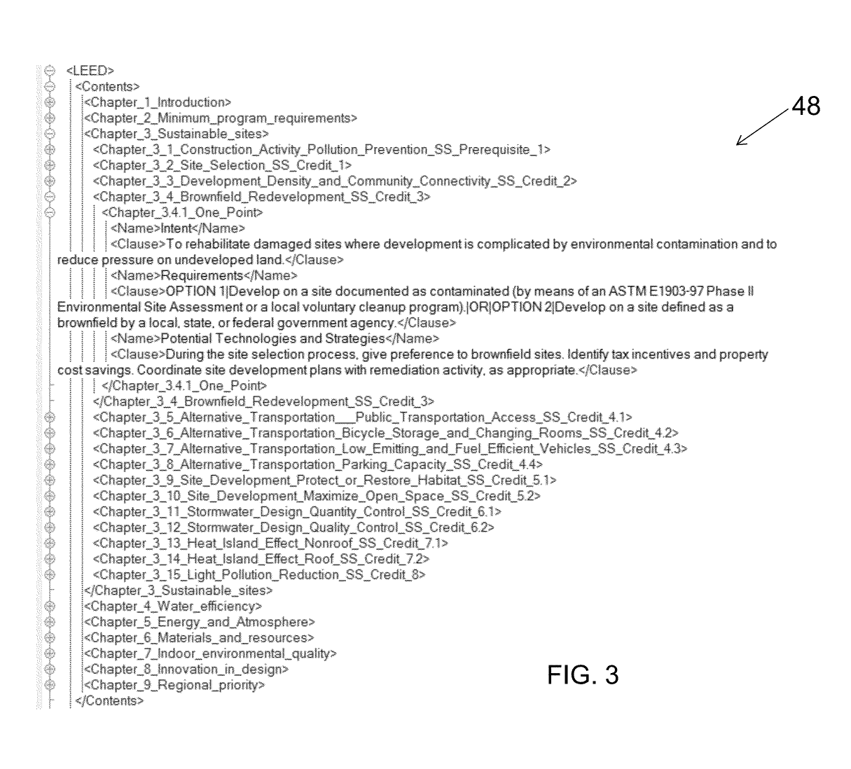

The LEED 2009 NC standard 14 is available online for public download (USGBC, 2011b). A semi-automated process is created to transform the static standard into an XML-based data structure, as shown in FIG. 2. First, the PDF-format standard 14 is manually transformed into the Microsoft Word-format document 46. Then the Microsoft Word-format document 46 is converted automatically to an XML file named “LEEDXML-Reference” 16 by manually initiating a Java program of the present invention. FIG. 3 illustrates a screen shot 48 of the LEEDXML-Reference file 16 in the XMLSpy program (Altova. (2012), “Download XML Editor—Altova® XMLSpy® 2012 Enterprise Edition”. Available at: http://www.altova.com/download/xmlspy/xml_editor_enterprise.html). The LEEDXML-Reference 16 acts as a supporting data-structure for frontend code display and user interaction. This method facilitates converting otherwise static documents to an easily changeable form, as rating systems are constantly being updated

Online Submission Function 18

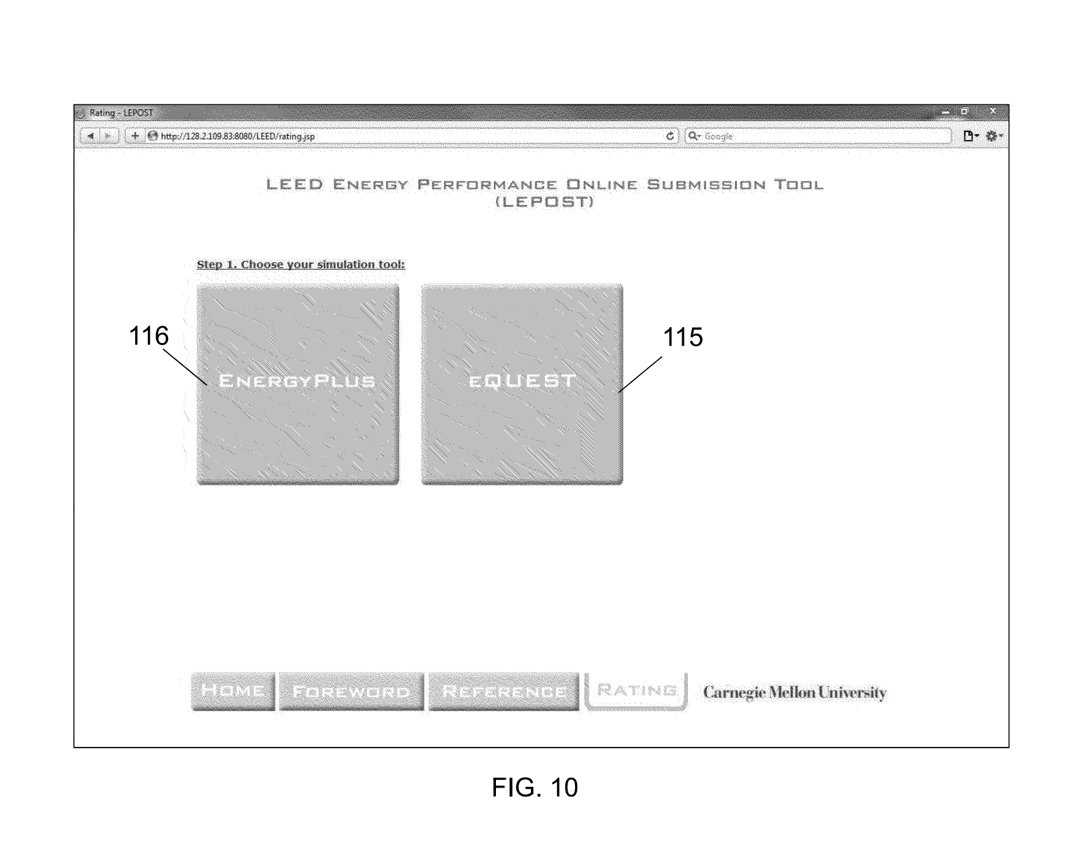

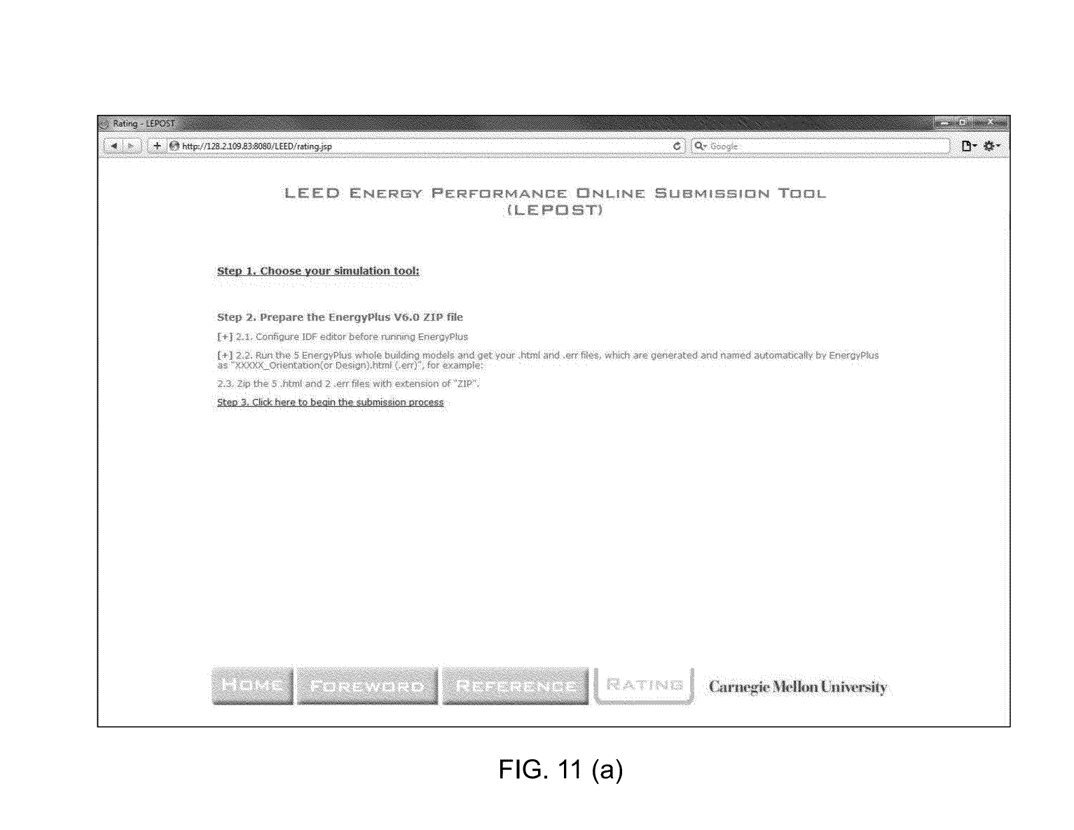

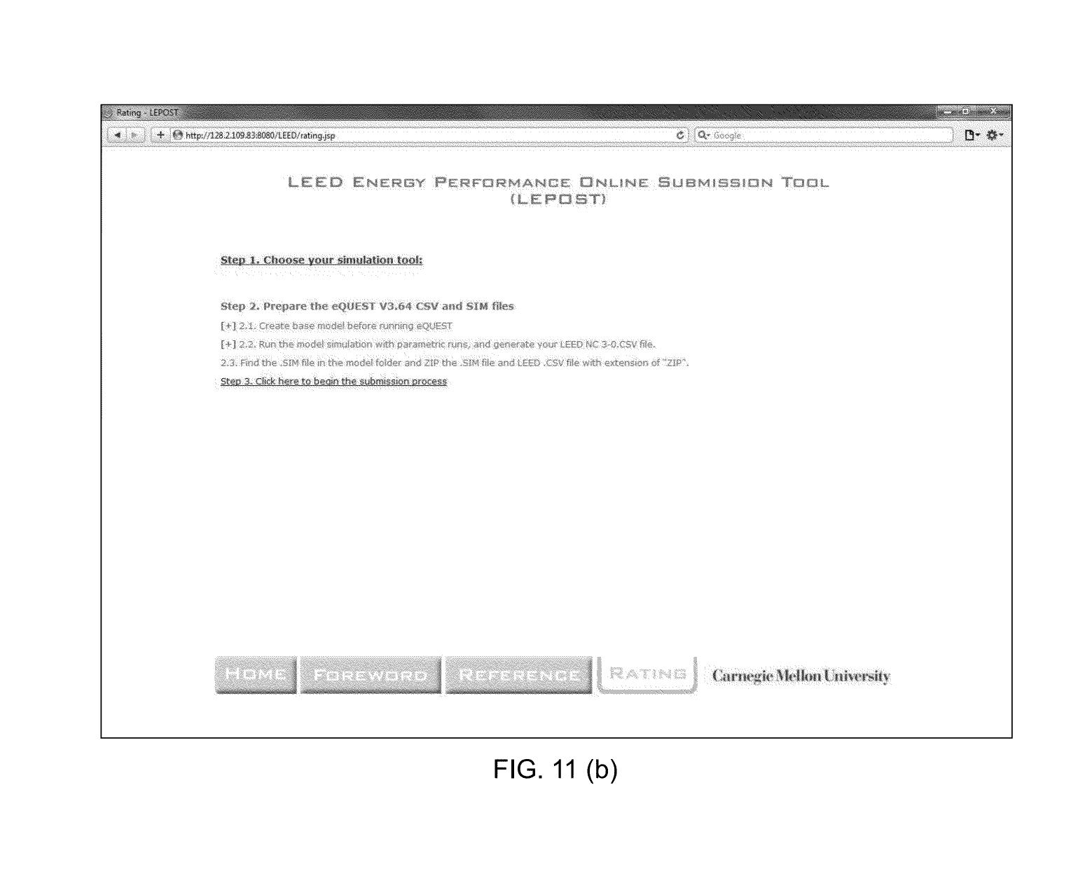

The starting point for online submission function 18 is Manual User Input 32. A user needs to choose whether to use EnergyPlus or eQUEST programs to move forward in function 114 (see FIG. 10 for the screenshot example). Based on the user's choice, EnergyPlus 116 or eQUEST 115 building energy model should be configured and simulated according to the instructions (see FIG. 11(a) and FIG. 11 (b) for the respective screenshot examples). Detailed procedures to generate EnergyPlus Model Output 106 and eQUEST Model Output 107 are as following,

A. EnergyPlus Model Output Preparation

According to the LEED NC 2009 EA Prerequisite 2, all the building energy models should be created by meeting the requirements in the ASHRAE 90.1-2007 Appendix G standard. US Green Building Council (USGBC) published a detailed guideline—“Advanced Energy Modeling for LEED” to assist energy modelers to build and simulate the energy model to achieve the EA requirements (USGBC (2011a), Advanced Energy Modeling for LEED. Washington D.C.: U.S. Green Building Council). Four baseline models with rotations at 0°, 90°, 180° and 270° orientations to the north axis, as well as the design case orientation models should be built using commercially available software tools that are outside the scope of this invention.

Three additional steps need to be accomplished to generate a standard EnergyPlus output file for LEPOST.

Step 1 (Block 115 of FIG. 1). Configure “IDF editor” before running EnergyPlus (V6.0 and above). EnergyPlus uses text-based files as basic input and output files. An “IDF Editor” is used to assist the text editing for input information. Table 1 shows configuration steps in the “IDF Editor”.

TABLE 1
EnergyPlus configuration before simulation.
“Output Reporting”

| 1. | Output: Table: SummaryReports -> Report 1 Name: | |
|---|---|---|
| | Allsummary | |
| 2. | OutputControl:Table:Style: | |
| | a. | Column Separator: HTML |
| | b. | Unit Conversion: JtoKWH |

| | |
|---|---|
| 3. | Name IDFs with “***_Orientation(or Design).idf” |

Step 2 (Block 106 of FIG. 1). Run the five EnergyPlus whole building models and get the five corresponding HTML-format result files and two (0 degree baseline model+Design case model) “.ERR” files, which are generated and named automatically by EnergyPlus as “***_Orientation (or Design).HTML (.ERR)”.

Step 3 (Block 110 of FIG. 1). Zip the five HTML-format files 106 and two .ERR files 106 with the extension of “***.ZIP” and upload to LEPOST “Model File ZIP, Upload, and Unzip” to form EnergyPlus Model Output 109.

B. eQUEST Model Output Preparation

The baseline modeling in eQUEST is similar as the process for EnergyPlus. Four baseline models with 0°, 90°, 180° and 270° to the north axis and design model could be either built by using the embedded “Parametric Run” module in eQUEST or built separately. All the models should be compliant with ASHRAE 90.1-2007 Appendix G and LEED NC 2009 EA Prerequisite 2: Minimum Energy Performance. After the five eQUEST whole building models are created, two more steps should be achieved to generate the standard file for LEPOST:

Step 1 (Block 115 of FIG. 1). Run the five eQUEST models and get SIM-format file results.

Step 2 (Block 107 of FIG. 1). Use the eQUEST built-in module named “LEED Analysis Results (CSV) Generator” to generate a CSV-format file using the results of Step 1.

Step 3 (Block 110 of FIG. 1). Zip the CSV-format file generated by Step 2 and SIM-format file of the proposed design case model with the extension of “XXXX.ZIP” and upload to LEPOST.

Model File Zip, Upload, and Unzip

The user performs file Zip and uploads the zipped files manually. In Block 110, the zipped files are unzipped using standard Java library function to retrieve eQUEST Model Output 108 (the same as 107) and EnergyPlus Model Output 109 (the same as 106).

File Validator 30

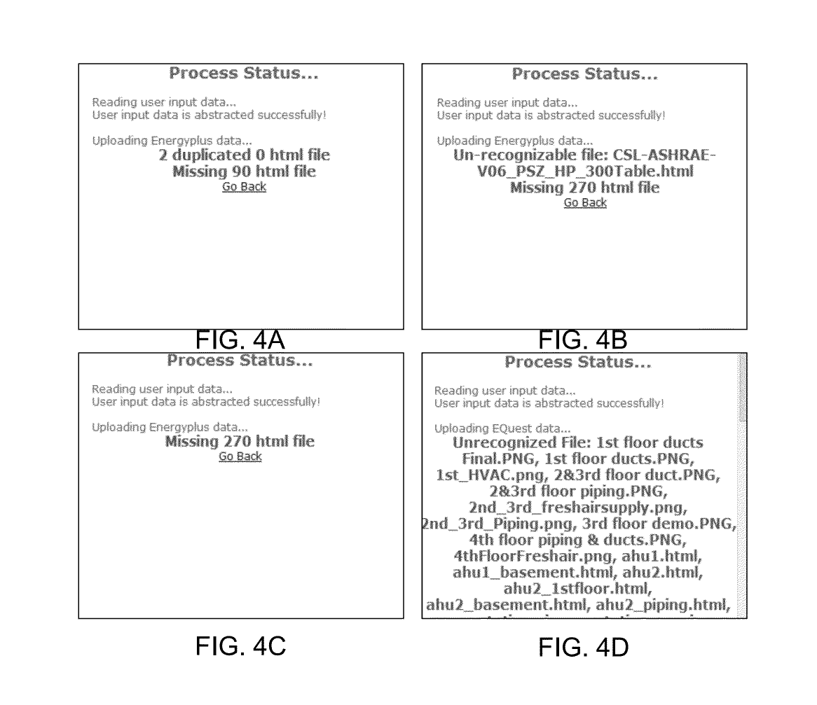

The “File Validator” 30 is implemented to perform integrity check for the EnergyPlus model simulation result files (Model Output 109). FIGS. 4A-D show some examples of error feedback through Process Status Indicator 83 for the uploaded ZIP files to assist users to check the completion of their submissions. The eQUEST Model Output 108 does not need the user's interaction and therfore does not need an integrity check with the “File Validator” 30. Any errors that occur during “File Validator” 30 process will be sent to Process Status Indicator 83.

Text File Transformer 28

A unique ID is allocated by “Text File Transformer” 28 for each data field to be filled in the LEEDXML-template 38. The techniques for aggregating and representing data are well known in the art. Any errors that occur during “Text File Transformer” 28 process will be sent to Process Status Indicator 83.

Support Data Processor 24

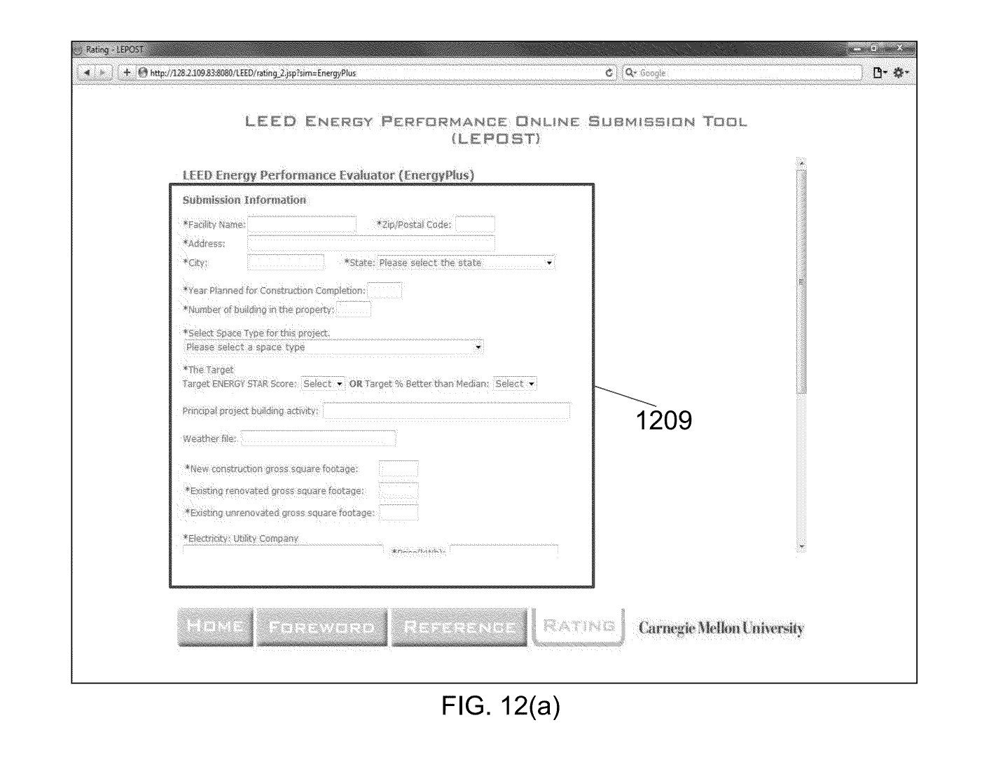

More than 70% of the information for the LEED EA Prerequisite 2 and Credit 1 can be automatically filled with energy simulation results from the output files directly. Besides Manual User Input 32 discussed above, two other manual inputs go to the “Result Calculator” 101 and “EnergyStar Request Processor” 102. Table 2 shows the detailed information of the manual input for Result Calculator 101 and EnergyStar Request Processor 102. Input fields 109 in FIG. 12(a) shows the user interface for the manual inputs.

TABLE 2
Manual user input for EnergyStar Target Finder in 102
and LEED point calculations in 101

| Manual user input for Energy Star | Manual user input for LEED point |
|---|---|
| Target Finder calculation | calculation |
| Facility Name | Principal project building |
| Zip/Postal Code | activity |
| Address | Weather file |
| City | New construction gross square |
| State | footage |
| Year Planned for Construction | Existing renovated gross square |
| Completion | footage |
| Number of building in the | Existing renovated gross square |
| property | footage |
| Select Space Type for this | |
| project | |
| The Target | |
| Electricity: Utility Company & | |
| Price (kWh) | |
| Natural Gas: State & Price | |
| (kWh) | |

Web Extracting Function 50

Utility rates need to be filled in to calculate energy cost information by both “Result Calculator” 101 and “EnergyStar Request Processor” 102. Web extracting function 50 creates a link to the Energy Information Agency (EIA) database (EIA. (2012), “Eletricity Data”: Energy Information Administration. Available at: http://www.eia.gov/electricity/data.cfm#sales) and returns current (updated periodically by the EIA) electricity and natural gas prices for energy cost calculation in Result Calculator 101 based on zip codes and utility company names from manual user input 32

LEEDXML-Template 38

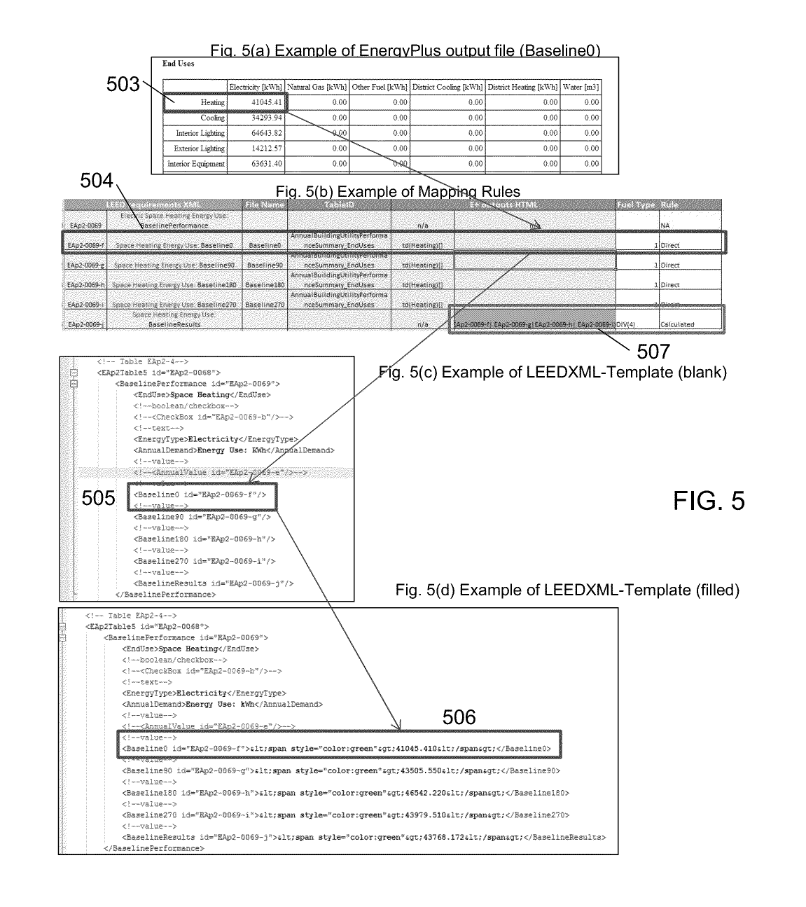

The original fillable PDF-format LEED EAP-2 and EAC-1 submission forms provided by USGBC are transformed to be LEEDXML-Templates. The XML data structure is adopted due to its extensibility and the ability to exchange and aggregate a wide variety of data on the web. To view the template online, HTML-format files are created via XSLT transformations of the LEEDXML-Templates 38 (W3C. (2012), “Extensible Markup Language (XML)”. Available at: http://www.w3.org/XML/). See FIG. 5(c) for an example of the blank LEEDXML-Template and FIG. 5(d) for an example of the filled LEEDXML-Template. Each fillable blank has its unique ID to be used by Mapping Engine 82.

The Mapping Rule 36 defines four categories for the fillable fields in the LEEDXML-Template 38—“Direct,” “Document,” “Other,” and “Calculated.” (1) “Direct” refers to the data that is readily available in the EnergyPlus or eQUEST output files 108 or 109; (2) “Document” refers to the fields where user needs to upload certain documents separately, such as design drawings and architect's signature, which is not included in this invention; (3) “Other” indicates special circumstances where data has to be retrieved from other web sources (Web Extracting routine 50, FIG. 1), such as current utility rates (Utility data 34, FIG. 1) or the data that are not available for filling the blanks; and (4) “Calculated” indicates the fields that need to be calculated based on the three types of information above, such as energy cost and final LEED points, performed by “Result Calculator” 101 in FIG. 1. The Mapping Rule file 36 (see an example 504 in FIG. 5(b)) is created manually once and is read only by the Mapping Engine 82 and Result Calculator 101 thereafter.

Mapping Processor 22

Result Calculator 101

Result Calculator 101 processes the model data transformed by Text File Transformer 28 and Manual User Input 32 (the second column in Table 1) with the required calculations by LEED EAP-2.

Example [1] is to calculate the heating energy cost by multiple heating energy consumption data from Text File Transformer 28 and electricity price data from Utility Data 34.

Example [2] is to calculate final LEED points by compare the total annual energy cost savings with the lookup table (Table 3) defined by the USGBC based on whether the project is a new building (>=60% of the building is new construction) or existing building renovation project (<60% of the building is new construction).

TABLE 3
The minimum energy cost savings percentage for each point threshold
(http://www.usgbc.org/Docs/Archive/General/Docs5546.pdf)

| New Buildings | Existing Building Renovations | Points |
|---|---|---|
| 12% | 8% | 1 |
| 14% | 10% | 2 |
| 16% | 12% | 3 |
| 18% | 14% | 4 |
| 20% | 16% | 5 |
| 22% | 18% | 6 |
| 24% | 20% | 7 |
| 26% | 22% | 8 |
| 28% | 24% | 9 |
| 30% | 26% | 10 |
| 32% | 28% | 11 |
| 34% | 30% | 12 |
| 36% | 32% | 13 |
| 38% | 34% | 14 |
| 40% | 36% | 15 |
| 42% | 38% | 16 |
| 44% | 40% | 17 |
| 46% | 42% | 18 |
| 48% | 44% | 19 |

Any errors that occur during “Result Calculator” 101 process will be sent to Process Status Indicator 83.

EnergyStar Request Processor 102

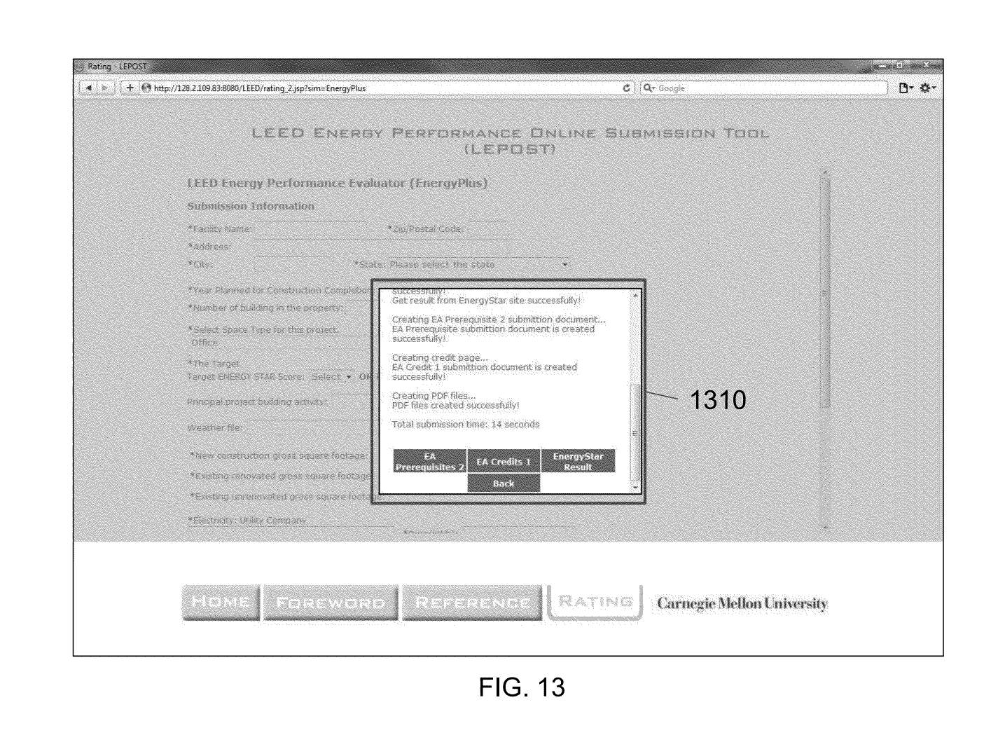

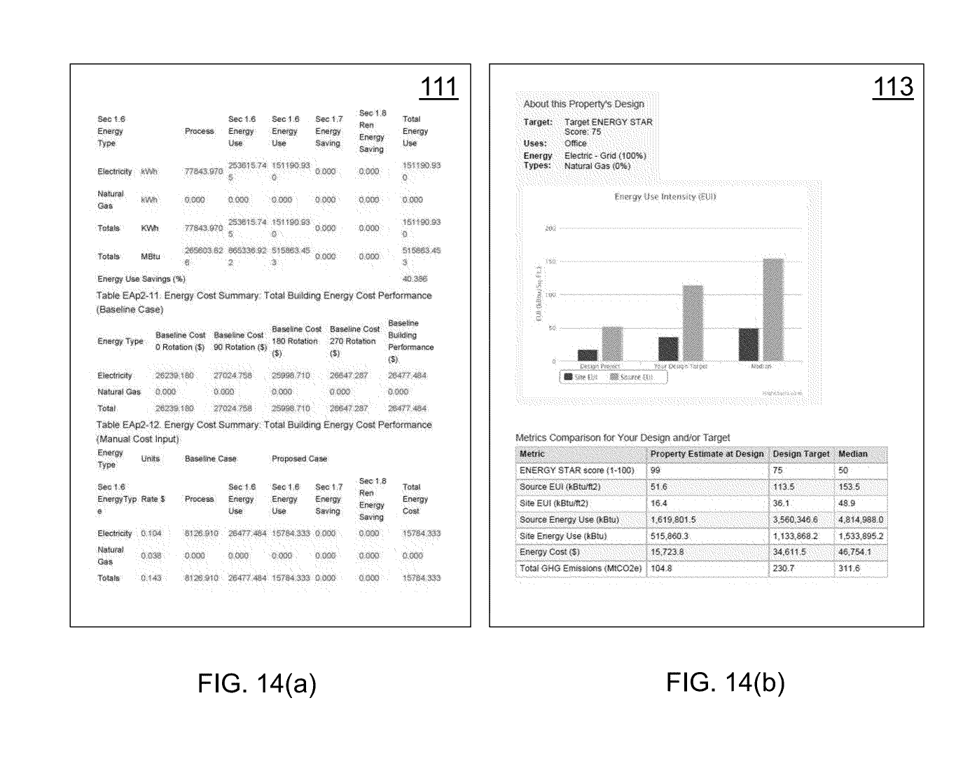

Data entry of the EnergyStar Target Finder (EnergyStar. (2013), “Target Finder Services”. Available at: http://portfoliomanager.energystar.gov/webservices/home/api/targetFinder), as part of the LEED EA requirements, is required for an externally invoked calculation tool. The current practice for LEED submission requires users to go to the EnergyStar website to invoke the calculation and manually enter the result data into the LEED submission template, whereas LEPOST is able to automatically transfer the data entered in the tool to the EnergyStar website and return the result back to LEPOST (Process 102 in FIG. 1). Energy Star Portfolio Manager—Target Finder Services is used to retrieve and populate the data (EnergyStar, 2013)). EnergyStar Request Processor 102 takes in Manual User Input 32 (the first column in Table 2) and Utility Data 34 and uses the two pieces of data to assemble and send the EnergyStar Target Finder web service request. Then the EnergyStar Request Processor 102 reads and parses the EnergyStar Target Finder server response. The EnergyStar Request Processor 102 sends any error messages returned from the EnergyStar Target Finder server to web user in Process Status Indicator 83. FIG. 14(b) shows an example of the EnergyStar output result file.

A possible error could occur when the Energy Star Target Finder server or the connection between LEPOST and the server is dysfunctional. If this problem occurs, users can still get a partially filled LEED submission files 111 and 112 without the Energy Star Target Finder Result Page 113.

Mapping Engine 82

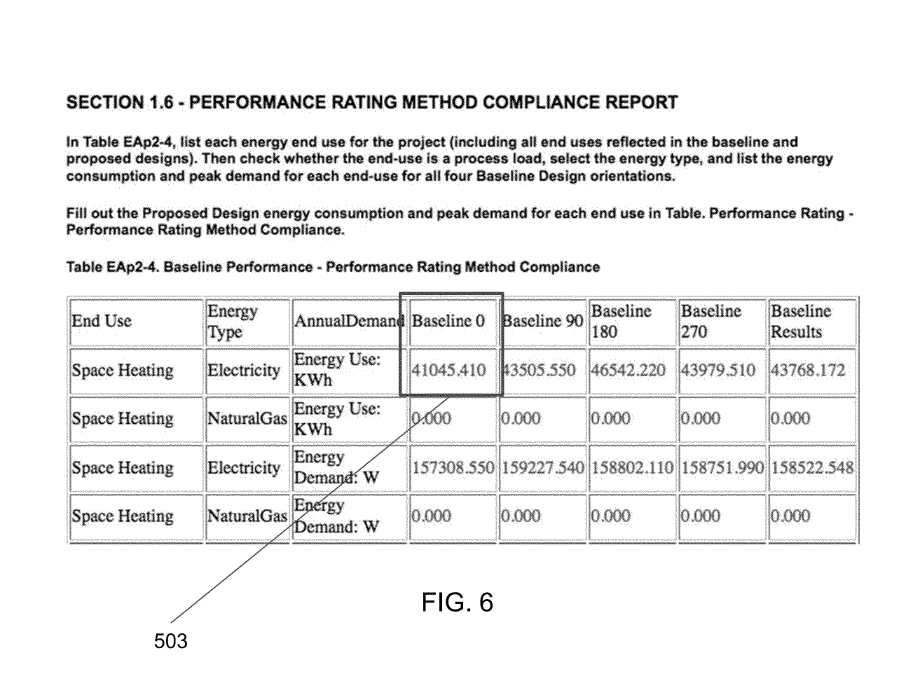

Based on the predefined Mapping Rule 36, the Mapping Engine 82 inserts the data with unique IDs (variable names) from Result Calculator 101 and the Utility Data 34 into the 2 LEEDXML-Templates 38 (LEEDXML Template EAP-2 and LEEDXML Template EAC-1). These filled LEEDXML-Templates will then be used by Report Generator 42. FIG. 5(b) shows an example of the “Direct” mapping process identifying unique data 104 from the Mapping Rules 36 for insertion into a predetermined blank “value” field 505 of LEEDXML template 38 resulting in filled “value” field 106 to fill-in the LEEDXML template 38. Block 504 defines the LEED requirements from the LEEDXML template “Space Heating Energy Use: Baseline0” with a unique ID “EAp2-0069-1”. The File Name of where the data belongs to is Baseline0 (see FIG. 5a where Heat-Electricity (KWh) is 41045.41 (Block 503). The Fuel Type column in Block 504 corresponding to the column number of FIG. 5(a), in this case, “1” means “electricity”. The mapping rule in Block 504 is “Direct,” meaning the number “41045.41” in Block 503 can be directly filled in the LEEDXML-Template in Block 505. The end result of this mapping instance shows in Block 506 in FIG. 5(d). FIG. 6 shows value 503 in the final report after the XML file is converted to pdf.

FIG. 5(b), Block 507 shows an example of the “Calculated” mapping process. It defines that the values in “EAp2-0069-1”, “EAp2-0069-g”, “EAp2-0069-h”, “EAp2-0069-i” need to be summed up and divided by 4 to get the average value of all the baseline cases, for example, Space Heating Energy Use.

Process Status Indicator 83

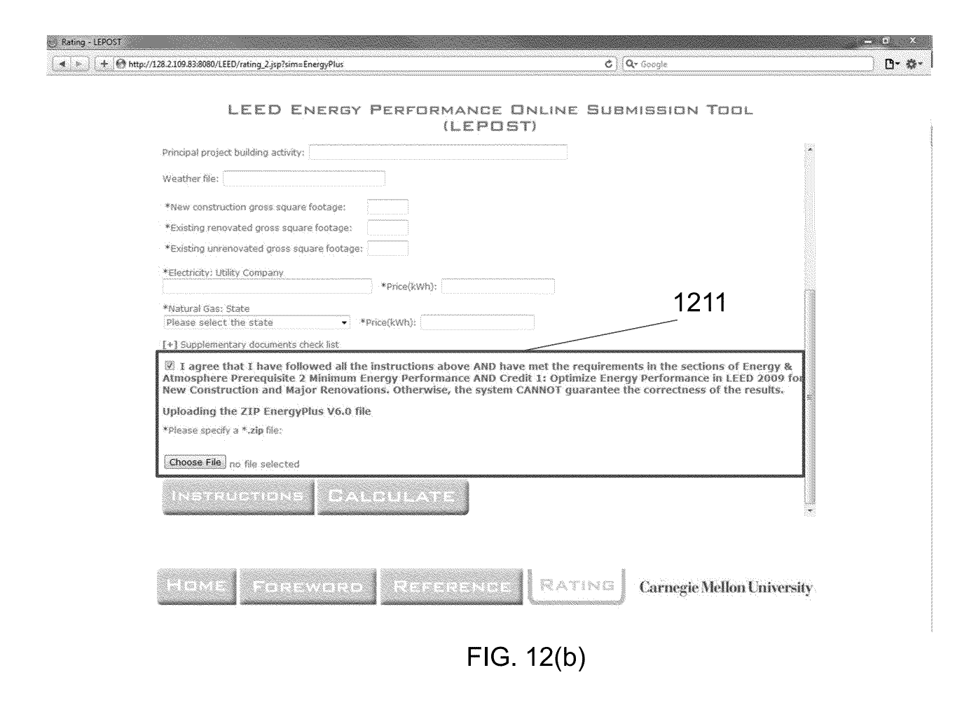

Process Status Indicator gives users the real-time feedback of the entire mapping processes in File Validator, Text File Transformer, Result Calculator, EnergyStar Request Processor, and Mapping Engine (30, 28, 101, 82, and 102). FIGS. 4A-D show the uploaded file errors occurred in File Validator 30. 110 in FIG. 13 shows the completion status and the buttons for users to download LEED EAP-2 Submission Document 111, LEED EAC-1 Submission Document 112, and EnergyStar Target Finder Result Page 113.

Report Generator 42 and PDF Generator 44

Report Generator 42 will transform the two filled LEEDXML Templates (EAP-2 and EAC-1) 38 from Mapping Engine 82 and generate two HTML files. Report Generator 42 also takes in the EnergyStar web service results and generate an HTML file. A generic PDF Report Generator 44 converts the three HTML files to PDF-format LEED EAP-2 Submission Document 111 (see FIG. 14(a)), EAC-1 Submission Document 112, and EnergyStar Target Finder Result Page 113 (see FIG. 14(b)). Users can download the three PDF files at the result page of the invention (see popup window 1310 in FIG. 13).

Results

User Interface

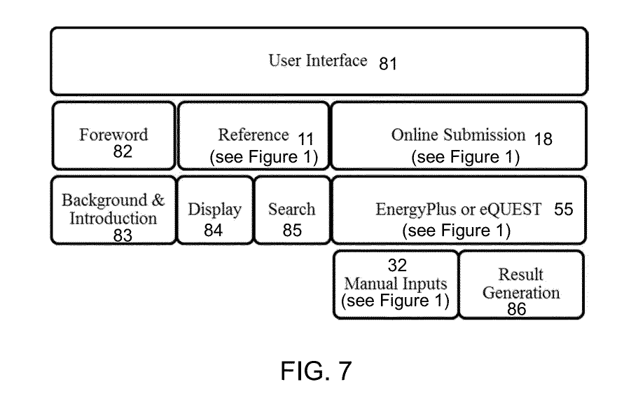

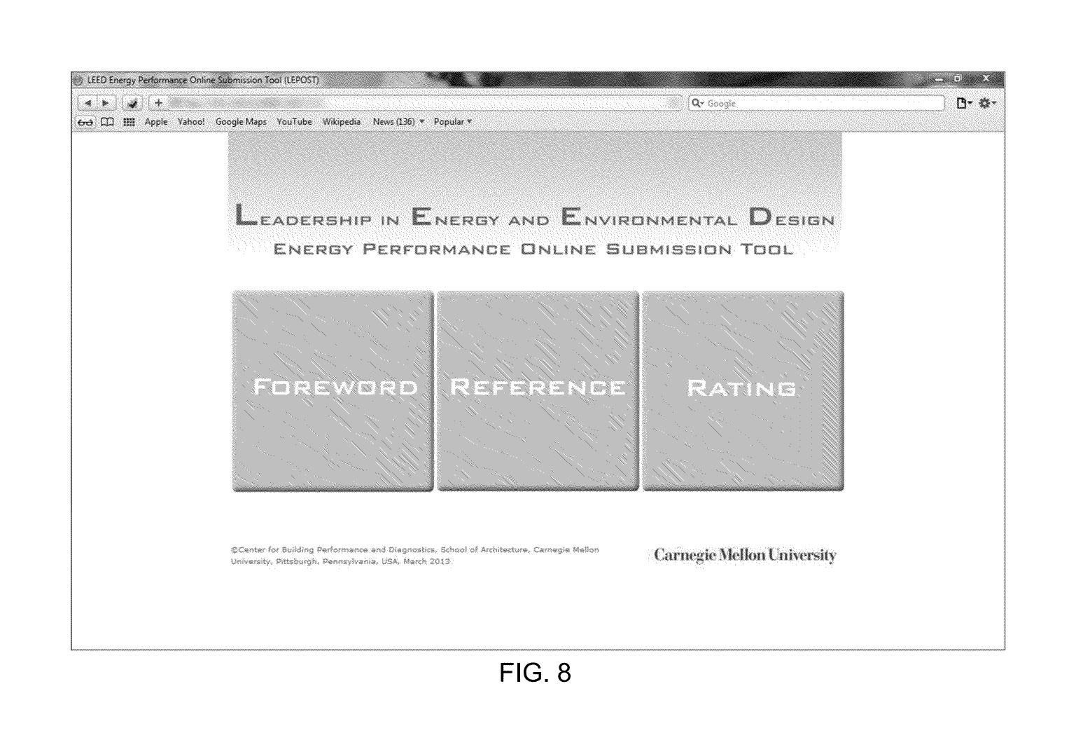

User interface 81 navigation structure is shown in FIG. 7: Foreword 82, Background and Introduction 83, Reference 11 (see FIG. 1), Display 84, Search 85, Online Submission 18 (see FIG. 1), EnergyPlus or eQUEST 55 (see FIG. 7), Manual User Inputs 32 (see FIG. 1), and Result Generation 86. Pushing Foreword 82 button (see FIG. 8) brings users to Background and Introduction 83 of the tool. Pushing Re

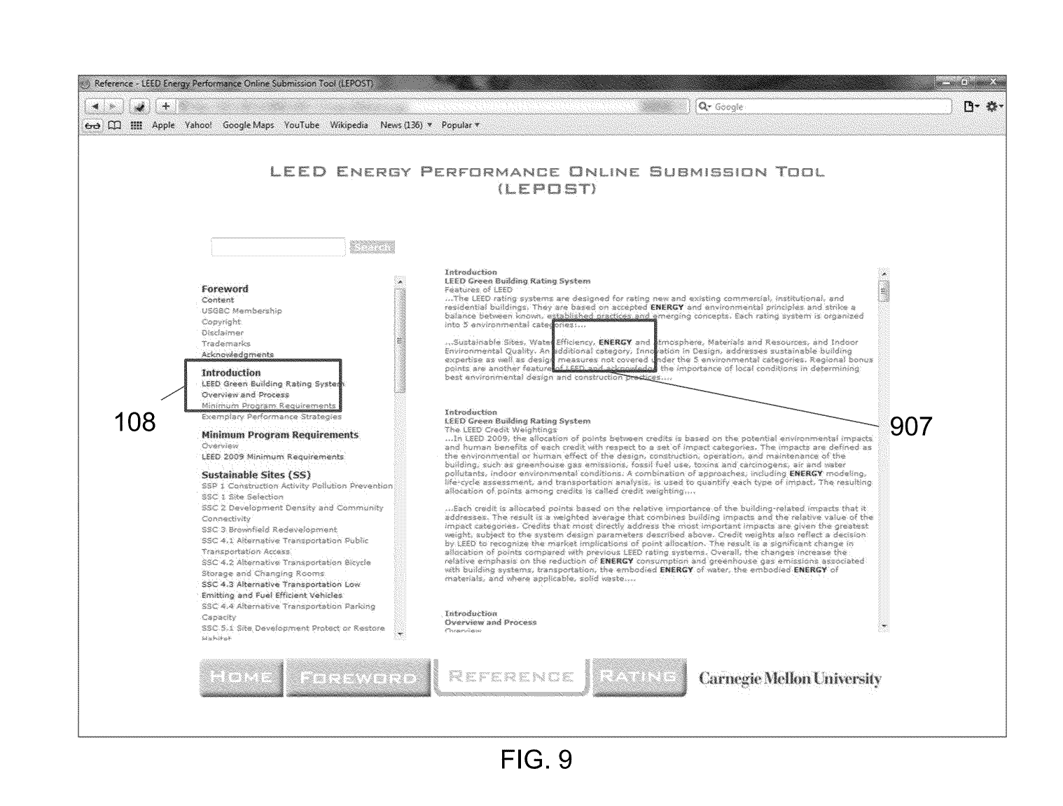

Pushing “Reference” 11 button (see FIG. 8) brings users to Display 84 and Search 85 functions. Clicking the clause on the left side of in FIG. 9 shows the content of the clause. Searching a keyword shows users the highlighted clauses 108 and the keyword in the contents of the clauses 107.

Pushing “Rating” button (see FIG. 8) brings users to Step 1 of the Online Submission (see FIG. 10) for choosing EnergyPlus or eQUEST (see 114 in FIG. 1). Pushing either EnergyPlus or eQUEST button brings users to Step 2 of the Online Submission (see FIGS. 11 (a) and 11(b)). Clicking “Step 3. Click here to begin the submission process” brings users to Step 3 of the Online Submission (see FIG. 12(a)). Users should fill in all the blanks 109 and click the checkbox 1211 in FIG. 12(b)) of “I agree that I have followed all the instructions above AND have met the requirements in the sections of Energy & Atmosphere Prerequisite 2 Minimum Energy Performance AND Credit 1: Optimize Energy Performance in LEED 2009 for New Construction and Major Renovations. Otherwise, the system CANNOT guarantee the correctness of the results.” Then users can click “Choose File” to upload either EnergyPlus or eQUEST Model Output zip files (see Block 106 or Block 107 in FIG. 1). Pushing Instructions button brings users to Step 1. Push “Calculate” button brings users to Process Status Indicator 83 (1310 in FIG. 13). Process Status Indicator 83 has four buttons. Users can download the “EA Prerequisites 2” 111, “EA Credit 1” 112, and “EnergyStar Result” 113 by pushing the corresponding buttons. The “Back” button brings user back to Step 3 (see FIG. 13). The data extracting, mapping, and report generation functions are hidden from users, but the process status feedback is displayed for users in real time. User interface screenshots of LEPOST are shown in FIG. 8-FIG. 14(b) using Safari web browser in Windows 7 OS.

Result Generation

The final outputs of the tool are three sets of PDF format documents: the LEED EA Prerequisite 2 submission document 111, the LEED EA Credit 1 submission document 112, and the Energy Star Target Finder Result Page 113 (discussed in detail above). The sample report pages are illustrated in FIGS. 14(a) and 14(b). Supplementary documents, such as design specifications and architect's signature, are required for submission but are beyond the scope of LEPOST.

There are two main challenges of developing this tool. First, different energy simulation tools have different result output file formats. Those files contain different information that may or may not be useful for the LEED submission. Therefore, for each energy simulation tool, manual work is needed to identify and structure the data from the simulation result output files. If the result output file already uses a structured format, such as HTML-format or CSV-format, the data extraction can be achieved within a short time period. But if the result output file is in a text-based format, such as SIM-format used in eQUEST, identifying useful information from the text file can be time consuming for the first time development task. Once the useful data are identified, extracting and mapping to the LEEDXML-Template is relatively straightforward.

Second, some part of the calculation relies on other web-based engines and databases. For example, Energy Star rating result page is calculated in Energy Star Target Finder engine. The web API technology is used to enter and retrieve data from the web service. The completeness and robustness of the tool is affected by the stability of those web services. To solve this problem, LEPOST is designed to bypass such related function if the web service does not response to the call within 10 seconds.

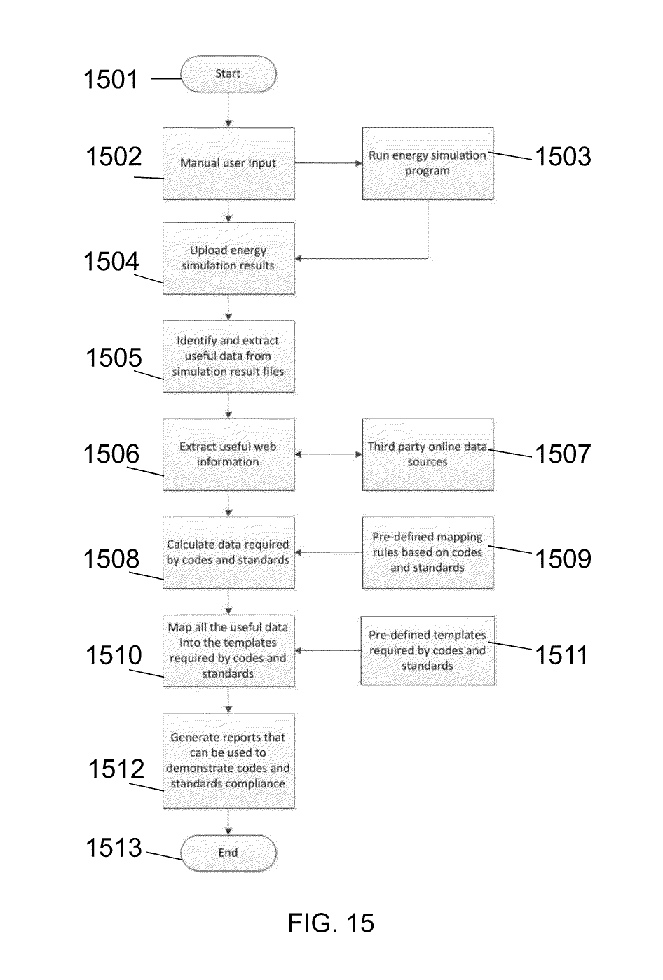

FIG. 15 summarizes the core processes of the present invention. When the website is launched in Block 1501, some user input (Block 1502) is needed for choosing an energy simulation program (Block 1503) and for other necessary information to move forward. In Block 1504, the user needs to upload the energy simulation results from Block 1503. Then required data are identified and extracted from the simulation result files in Block 1505. Then required web information is extracted in Block 1506 from third party online data sources 1507. With all the data above (from the user, simulation result, and web), in Block 1508 the calculations are performed based on the mapping rules 36 (FIG. 1) predefined by the requirements in codes and standards 1509. Then all the required data are mapped into the templates 38 (Block 1511) required by codes and standards in 1510. Next, those filled templates are transformed into reports 111, 112, 113 (FIG. 1) that can be used to demonstrate codes and standards compliance.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method to populate a form comprising the steps of:
providing a processor in communication with a user input device, a storage device, and a database to execute the following steps of the method:
prompting a user to input a first set of data with the user input device;
prompting the user to import one or more files from the storage device;
extracting a second set of data from the one or more files;
extracting a third set of data from the database based on the user input;
calculating a fourth set of data based on one or more data selected from the group consisting of the first set of data, the second set of data, and the third set of data;
assigning a data unique identifier to each data of the first set of data, the second set of data, the third set of data, and the fourth set of data;
providing a template of the form with one or more fill-in fields, wherein each fill-in field of the one or more fill-in fields is assigned a field unique identifier that corresponds directly with one or more data unique identifiers of the each data of the first set of data, the second set of data, the third set of data, and the fourth set of data;
mapping data from at least two of the first set of data, the second set of data, the third set of data, and the fourth set of data into the one or more fill-in fields of the template based on common unique identifiers to form a filled template; and
converting the filled template into the form.

2. The method according to claim 1, wherein the one or more files device contain digital representations of a building.

3. The method according to claim 1, wherein the one or more files are Energy Plus output files.

4. The method according to claim 1, wherein the one or more files are eQUEST output files.

5. The method according to claim 1, wherein the database is an EnergyStar database.

6. The method according to claim 1, wherein the step of extracting a third set of data from the database based on the user input further comprises the steps of linking to a third party website to retrieve current information from a third party database.

7. The method according to claim 7, wherein the third party database is an Energy Information Agency (EIA) database.

8. The method according to claim 8, wherein the current information is electricity and natural gas prices.

9. The method according to claim 1, wherein the input is one or more input selected from the group consisting of: Facility Name, Zip/Postal Code, Address, City, State, Year Planned for Construction Completion, Number of building in the property, Select Space Type for this project, The Target, Electricity: Utility Company & Price (kWh), Principal project building activity, Weather file, New construction gross square footage, Existing renovated gross square footage, Existing renovated gross square footage, and Natural Gas: State & Price (kWh).

10. The method according to claim 1, wherein the step of calculating a fourth set of data based on one or more data selected from the group consisting of the first set of data, the second set of data, and the third set of data further comprises the steps of:
providing a calculation field with predetermined variables;
identifying the predetermined variables in the one or more data;
calculating the fourth set of data; and
filling the template of the form with the calculated fourth set of data.

11. The method according to claim 11, wherein the calculation field is in a mapping rules file.

12. The method according to claim 1, wherein the step of mapping data from at least two of the first set of data, the second set of data, the third set of data, and the fourth set of data into the one or more fill-in fields of the template based on common unique identifiers to form a filled template, further comprised the steps of:
providing a mapping rules file having designations for a direct input and a calculated input,
wherein the direct input is extracted from one or more of the first set of data, the second set of data, the third set of data, and the fourth set of data, and
wherein the calculated input is derived from an equation embedded in the mapping rule utilizing values extracted from one or more of the first set of data, the second set of data, the third set of data, and the fourth set of data, and
mapping the direct input and the calculated input into the template of the form to form the filled template of the form.

13. The method according to claim 1, wherein the filled template of the form is an XLM file, and wherein the step of converting the filled template into the form further comprising the step of converting the XLM file into a PDF.

14. The method according to claim 4, wherein the one or more eQUEST output files are CSV format files, and wherein the step of prompting the user to import one or more files from the storage device further comprises the step of converting the CVS format files into HTLM format files.

15. The method according to claim 1, further comprising the step of displaying progress status.

16. The method according to claim 1, wherein the form is a building code and standards compliance form.

17. The method according to claim 1, wherein the form is a LEED EAP-1 submission document.

18. The method according to claim 1, wherein the form is a LEED EAP-2 submission document.

19. The method according to claim 1, wherein the form is an EnergyStar Target Finder Result Page.

20. A method to populate a building code and standards compliance form comprising the steps of:
providing a processor in communication with a user input device, a storage device, and a database to execute the following steps of the method:
prompting a user to input a first set of data with the user input device, wherein the input is one or more input selected from the group consisting of: Facility Name, Zip/Postal Code, Address, City, State, Year Planned for Construction Completion, Number of building in the property, Select Space Type for this project, The Target, Electricity: Utility Company & Price (kWh), Principal project building activity, Weather file, New construction gross square footage, Existing renovated gross square footage, Existing renovated gross square footage, and Natural Gas: State & Price (kWh);
prompting the user to import one or more files from the storage device, wherein the one or more files device contain digital representations of a building;
extracting a second set of data from the one or more files;
extracting a third set of data from the database based on the user input, wherein the database is an EnergyStar database;
calculating a fourth set of data based on one or more data selected from the group consisting of the first set of data, the second set of data, and the third set of data;
assigning a data unique identifier to each data of the first set of data, the second set of data, the third set of data, and the fourth set of data;
providing a template of the form with one or more fill-in fields, wherein each fill-in field of the one or more fill-in fields is assigned a field unique identifier that corresponds directly with one or more data unique identifiers of the each data of the first set of data, the second set of data, the third set of data, and the fourth set of data;
mapping data from at least two of the first set of data, the second set of data, the third set of data, and the fourth set of data into the one or more fill-in fields of the template based on common unique identifiers to form a filled template; and
converting the filled template into the building code and standards compliance form.

21. The method according to claim 20, wherein the one or more files are Energy Plus output files.

22. The method according to claim 20, wherein the one or more files are eQUEST output files.

23. The method according to claim 20, wherein the building code and standards compliance form is a LEED EAP-1 submission document.

24. The method according to claim 20, wherein the building code and standards compliance form is a LEED EAP-2 submission document.

25. The method according to claim 20, wherein the building code and standards compliance form is an EnergyStar Target Finder Result Page.
